(19) United States
(12) Patent Application Publication
(10) Pub. No.: US 2013/0204483 A1
(43) Pub. Date: Aug. 8, 2013

(54) ROBOT CLEANER

(71) Applicants: Chulmo SUNG, Seoul (KR); Seongsoo Lee, Seoul (KR); Dongki Noh, Seoul (KR); Donghoon Yi, Seoul (KR); Seungmin Baek, Seoul (KR)

(72) Inventors: Chulmo SUNG, Seoul (KR); Seongsoo Lee, Seoul (KR); Dongki Noh, Seoul (KR); Donghoon Yi, Seoul (KR); Seungmin Baek, Seoul (KR)

(21) Appl. No.: 13/757,985

(22) Filed: Feb. 4, 2013

(30) Foreign Application Priority Data
Feb. 4, 2012 (KR) 10-2012-0011534

(51) Int. Cl. A47L 11/40

(52) U.S. Cl. CPC A47L 11/4061
USPC 701/28

(57) ABSTRACT

A robot cleaner is provided. The robot cleaner may include a casing including a moving device, an image input disposed in the casing, the image input including a plurality of light emitting parts that emits light toward an obstacle and an image sensor that acquires a 3D image of the obstacle onto which the light is emitted by the plurality of light emitting parts, and a main controller that extracts 3D data with respect to the obstacle from the 3D image of the obstacle acquired by the image input to control the moving device.

### CROSS-REFERENCE TO RELATED APPLICATION(S)

The present application claims priority under 35 U.S.C. 119 and 35 U.S.C. 365 to Korean Patent Application No. 10-2012-0011534, filed in Korea on Feb. 4, 2012, which is hereby incorporated by reference in its entirety.

### BACKGROUND

1. Field

A robot cleaner is disclosed herein.

2. Background

Robot cleaners are known. However, they suffer from various disadvantages.

### BRIEF DESCRIPTION OF THE DRAWINGS

Embodiments will be described in detail with reference to the following drawings in which like reference numerals refer to like elements, wherein:

FIG. 1 is a front view of a robot cleaner according to an embodiment;

FIG. 2 is a schematic block diagram of the robot cleaner of FIG. 1;

FIG. 3 is a view illustrating a process of acquiring image date with respect to an obstacle by the robot cleaner of FIG. 1; and

FIG. 4 is a schematic block diagram of a robot cleaner according to another embodiment.

### DETAILED DESCRIPTION

Embodiments will be disclosed hereinbelow with reference to the accompanying drawings. Where possible, like reference numerals have been used to indicate like elements, and repetitive disclosure has been omitted.

Robot cleaners are home appliances that perform a cleaning operation while automatically moving. Such a robot cleaner may include all sorts of sensors to avoid interference or contact with obstacles during movement. For example, such a robot cleaner may include an infrared sensor that senses obstacles at a front thereof and a cliff sensor that senses cliffs in a floor surface.

Recently, such a robot cleaner may include a camera that photographs images of obstacles. Thus, the robot cleaner may extract data from the images photographed by the camera to recognize the obstacles. More particularly, to extract 3-dimensional (3D) data with respect to the obstacles, a special camera that photographs 3D images, for example, a stereo vision camera or a time of flight (TOF) camera may be provided in the robot cleaner.

However, related art robot cleaners may have the following limitations. In related art robot cleaners, a specific camera having a relatively high price may be provided to photograph 3D images of obstacles. Thus, as the specific camera is used, products may increase in unit cost.

Also, in the case of a stereo vision camera, resolution may deteriorate in proportion to a distance between the camera and an obstacle. Also, in the case of a TOP camera, resolution itself may be lower than that of the stereo vision camera. Thus, it is impossible to acquire stable and accurate 3D data of obstacles.

Also, a sensor that senses obstacles at a front thereof and a sensor that senses cliffs on a floor surface may be separately provided. Thus, the product may be complicated in configuration.

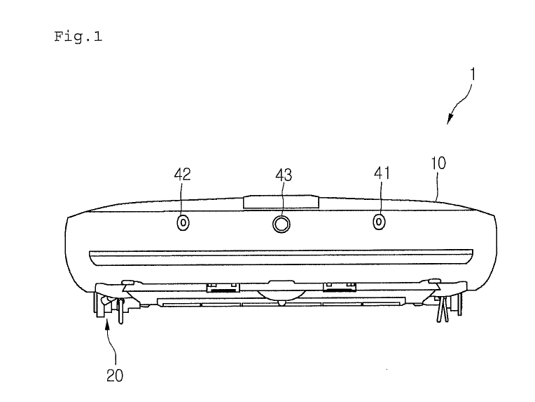

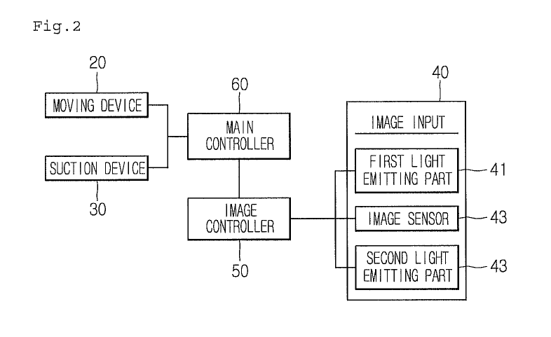

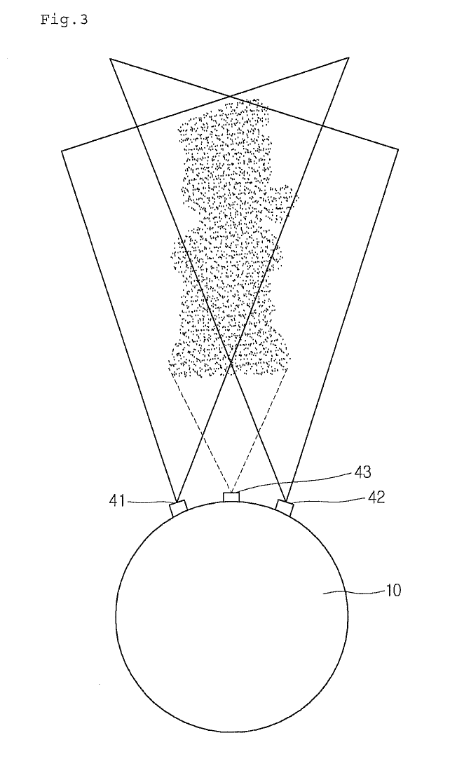

FIG. 1 is a front view of a robot cleaner according to an embodiment. FIG. 2 is a schematic block diagram of the robot cleaner of FIG. 1. FIG. 3 is a view illustrating a process of acquiring image date with respect to an obstacle by the robot cleaner of FIG. 1.

Referring to FIGS. 1 and 2, robot cleaner 1 may include a casing 10 that defines an outer appearance thereof. Various components of the robot cleaner 1 may be provided within the casing 10. The casing 10 may have, for example, a polyhedral shape; however, embodiments are not so limited. A suction opening (not shown), through which foreign substances may be suctioned into the casing 10, may be defined in a bottom surface of the casing 10.

The robot cleaner 1 may further include a moving device 20 that moves the robot cleaner 1. The moving device 20 may include a drive motor (not shown) and a drive wheel(s) (not shown), for example.

The robot cleaner 1 may further include a suction device 30 that suctions foreign substances. For example, the suction device 30 may include a suction motor (not shown) to suction foreign substances and a suction fan (not shown) rotated by the suction motor. Thus, when the suction device 30 is operated, foreign substances may be suctioned into the casing 10 through the suction opening.

The robot cleaner 1 may further include an image input 40. The image input 40 may acquire 3D images of an obstacle. The image input 40 may include, for example, two light emitting parts 41 and 42 and one image sensor 43.

In more detail, the light emitting parts 41 and 42 may include first and second light emitting parts 41 and 42. A laser diode that emits a laser beam toward an obstacle may be used as each of the first and second light emitting parts 41 and 42. The image sensor 43 may acquire 3D images of the obstacle onto which the light is emitted by the first and second light emitting parts 41 and 42. A laser camera that photographs images of the obstacle onto which the light is emitted by the first and second light emitting parts 41 and 42 may be used as the image sensor 43, for example.

Although this embodiment includes a plurality of light emitting parts provided in the casing 10, embodiments are not so limited. For example, only one light emitting part may be provided in the casing 10. In this case, the light emitting part may be installed on a moving device to increase an irradiation region of the light emitting part and also may be movably disposed within the casing 10.

The image sensor 43 may be disposed on a side of the case 10, for example, at a front surface of the casing 10. As shown in FIG. 3, when the casing 10 has a flat cylindrical shape with a circular cross-sectional area, the image sensor 43 may be disposed on an outermost side in a moving direction at an edge of the casing 10. The first and second light emitting parts 41 and 42 may be disposed on the edge of the casing 10 so that the first and second light emitting parts 41 and 42 are symmetrical to each other with respect to a center of the image sensor 43. That is, the image sensor 43 may be disposed between the first light emitting part 41 and the second light emitting part 42. The first and second light emitting parts 41 and 42 and the image sensor 43 may be horizontally or vertically disposed in a line. The first light emitting part 41 and the second light emitting part 42 may be disposed spaced apart from each other. A portion of an irradiation region in which light is emitted from the first light emitting part 41 may overlap an irradiation region in which light is emitted from the second light emitting part 42.

The robot cleaner 1 may further include an image controller 50 and a main controller 60. The image controller 50 may control an operation of the image input 40 to transmit the 3D image sensed by the image input 40, that is, by the image sensor 43, to the main controller 60. The main controller 60 may control operations of the moving device 20 and the suction device 30. The main controller 60 may extract 3D data with respect to the obstacle from the 3D image transmitted from the image controller 50. For example, the main controller 60 may include a structure light distance measurement device that analyzes a reflection pattern of light reflected by the obstacle from the 3D image received into the image sensor 43. The main controller 60 may control the operation of the moving device 20 so that the movement of the casing 10 does not interfere with the obstacle on the basis of the extracted 3D data with respect to the obstacle.

Hereinafter, an operation of a robot cleaner according to an embodiment will be described.

First, the moving device 20 and the suction device 30 may be operated to start movement of the casing 10 and suction of foreign substances. Thus, a cleaning operation to suction the foreign substances may be performed while the casing 10 is moved.

Then, the image input 40, that is, the first and second light emitting parts 41 and 42 and the image sensor 43, may be operated to acquire a 3D image(s) of an obstacle. That is, as shown in FIG. 3, the first and second light emitting parts 41 and 42 may emit light onto the obstacle, and the image sensor 43 may photograph the obstacle to acquire a 3D image(s) thereof.

Next, the main controller 60 may extract 3D data with respect to the obstacle from the 3D image(s) of the obstacle transmitted by the image controller 50. Also, the main controller 60 may control operations of the moving device 20 and the suction device 30 so that movement of the casing 10 does not interfere with the obstacle on the basis of the 3D data the obstacle. Thus, the cleaning operation may be performed without bumping into the obstacle while the casing 10 is moved.

With this embodiment, a relatively long focus distance may be secured using the light emitting parts 41 and 42 and the image sensor 43, which are relatively inexpensive, instead of a special camera to photograph a general 3D image. Also, when the light emitted by the first and second light emitting parts 41 and 42 is inclined downward, a 3D image with respect to a floor surface along which the casing 10 is moved may be photographed, and thus, 3D data of the floor surface may be acquired.

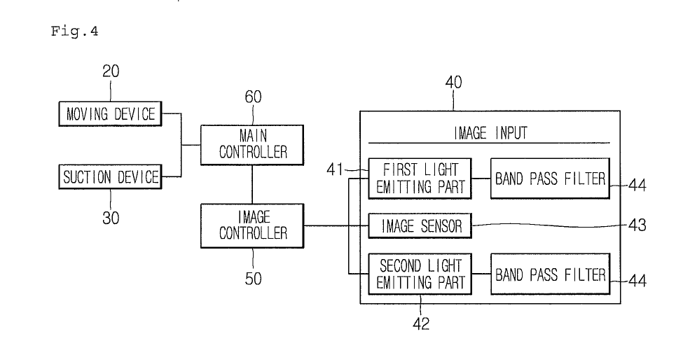

FIG. 4 is a schematic block diagram of a robot cleaner according to another embodiment. Like reference numerals have been used to indicate like elements with respect to the embodiment of FIGS. 1 to 3, and repetitive description has been omitted.

Referring to FIG. 4, an image input 40 according to this embodiment may further include a band pass filter 44. The band pass filter 44 may transmit only light having a predetermined wavelength of light emitted by first and second light emitting parts 41 and 42. For example, an infrared band pass filter that transmits only light having an infrared wavelength of the light emitted from the first and second light emitting parts 41 and 42 may be used as the band pass filter 44. Thus, only infrared light of the light emitted from the first and second light emitting parts 41 and 42 may pass through the band pass filter 44 and then be emitted toward an obstacle. Then, the infrared light may be reflected by the obstacle and received into the image sensor 43. An infrared camera capable of receiving the infrared light may be used as the image sensor 43, for example.

With this embodiment, as only the infrared light of the light emitted by the first and second light emitting parts 41 and 42 is emitted toward the obstacle, the light emitted by the first and second light emitting parts 41 and 42 is not recognized by a user during the cleaning operation of the robot cleaner. Also, in case in which the image sensor is an infrared camera, image acquisition errors due to light having a visible-light wavelength, except the light emitted by the first and second light emitting parts, may be reduced.

Embodiments disclosed herein provide a robot cleaner that may include a casing including a moving unit or device; an image input unit or image input disposed in the casing, the image input unit including a plurality of light emitting parts that emits light toward an obstacle and an image sensor that acquires a 3D image(s) of the obstacle onto which light is emitted from or by the plurality of light emitting parts; and a main control unit or controller that extracts 3D data with respect to the obstacle from the 3D image(s) of the obstacle acquired by the image input unit to control the moving unit.

Embodiments disclosed herein provide a robot cleaner that may include a casing that defines an outer appearance thereof; a (first) moving unit or device that moves the casing; a main control unit or controller that controls the moving unit; a laser diode disposed in the casing to emit laser light onto an obstacle; and a camera disposed in the casing to photograph a 3D image(s) of the obstacle. The main control unit may extract 3D data with respect to the obstacle from the 3D image(s) of the obstacle photographed by the camera to control an operation of the moving unit on the basis of the 3D data.

Embodiments disclosed herein provide a robot cleaner that performs a cleaning operation of suctioning foreign substances while being moved that may include an image input unit or image input including first and second light emitting parts that emit light having a preset pattern onto an obstacle disposed at a front side in a moving direction of the robot cleaner and an image sensor that photographs a 3D image(s) of the obstacle using the light emitted from or by the first and second light emitting parts; an image control part or controller that controls an operation of the image input unit; and a main control unit or controller that extracts 3D data with respect to the obstacle from the 3D image(s) of the obstacle acquired by the image input unit.

The first and second light emitting parts may be symmetrical with respect to each other with respect to a center of the image sensor. The image input unit may further include a band pass filter that transmits light having a specific wavelength of the light emitted from or by the plurality of light emitting parts, and the image sensor may receive the light having the specific wavelength passing through the band pass filter.

Embodiments disclosed herein provide a robot cleaner that may include a casing that defines an outer appearance thereof; a moving unit or device that provides a driving force to move the casing; a suction unit or device that provides a driving force to suction foreign substances into the casing; a main control unit or controller that controls operations of the moving unit and the suction unit; a laser diode disposed in the casing to emit laser light having a preset pattern onto the obstacle; a camera disposed in the casing to photograph a 3D image(s) of the obstacle; and an image control unit or controller that controls operations of the laser diode and the camera. The image control unit may transmit the 3D image(s) photographed by the camera to the main control unit. The main control unit may extract 3D data with respect to the obstacle from the 3D image(s) of the obstacle photographed by the camera to control the operation of the moving unit on the basis of the extracted 3D data.

Two laser diodes may be provided, such that the two laser diodes are symmetrical to each other with respect to the camera. The robot cleaner may further include a band pass filter that transmits light having a specific wavelength of the light emitted from or by the laser diode. The band pass filter may transmit light having an infrared wavelength, and the camera may receive infrared light.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A robot cleaner, including:
a casing including a moving device;
an image input disposed in the casing, the image input comprising at least one light emitting part that emits light toward an obstacle and an image sensor that acquires a 3D image of the obstacle onto which the light is emitted by the at least one light emitting part; and
a main controller that extracts 3D data with respect to the obstacle from the 3D image of the obstacle acquired by the image input to control the moving device.

2. The robot cleaner according to claim 1, wherein the at least one light emitting part comprises a first light emitting part and a second light emitting part.

3. The robot cleaner according to claim 2, wherein the image sensor is disposed between the first light emitting part and the second light emitting part.

4. The robot cleaner according to claim 2, wherein the first and second light emitting parts and the image sensor are vertically or horizontally disposed in a line.

5. The robot cleaner according to claim 4, wherein the first and second light emitting parts are disposed symmetrical to each other with respect to a center of the image sensor.

6. The robot cleaner according to claim 2, wherein a portion of an irradiation region of the light emitted by the first light emitting part overlaps an irradiation region of the light emitted by the second light emitting part.

7. The robot cleaner according to claim 1, wherein the image input further comprises at least one band pass filter that transmits light having a specific wavelength of light emitted by the at least one light emitting part, and wherein the image sensor receives the light having the specific wavelength passed through the band pass filter.

8. The robot cleaner according to claim 7, wherein the band pass filter transmits light having an infrared wavelength region, and wherein the image sensor comprises an infrared camera.

9. The robot cleaner according to claim 1, wherein each of the a least one light emitting part comprises a laser diode, and wherein the image sensor comprises a laser camera.

10. The robot cleaner according to claim 1, further comprising an image controller that controls an operation of the image input to transmit the 3D image sensed by the image sensor to the main controller.

11. The robot cleaner according to claim 1, wherein the main controller includes a structure light distance measurement device that analyzes a reflection pattern of light reflected by the obstacle from the 3D image received into the image sensor.

12. A robot cleaner, comprising:
a casing that defines an outer appearance thereof;
a first moving device that moves the casing;
a main controller that controls the moving device;
at least one laser diode disposed in the casing that emits laser light onto an obstacle; and
a camera disposed in the casing to photograph a 3D image of the obstacle, wherein the main controller extracts 3D data with respect to the obstacle from the 3D image of the obstacle photographed by the camera to control an operation of the moving device on the basis of the extracted 3D data.

13. The robot cleaner according to claim 12, wherein the at least one laser diode comprises a plurality of laser diodes disposed in the casing.

14. The robot cleaner according to claim 13, wherein the camera is disposed between the plurality of laser diodes.

15. The robot cleaner according to claim 13, wherein the plurality of laser diodes and the camera are vertically or horizontally disposed in a line.

16. The robot cleaner according to claim 13, wherein the plurality of laser diodes comprises first and second laser diodes, and wherein the camera is disposed between the first and second laser diodes.

17. The robot cleaner according to claim 12, further comprising a second moving device that moves the at least one laser diode to increase an irradiation region of the at least one laser diode.

18. The robot cleaner according to claim 12, further comprising a band pass filter that transmits light having a specific wavelength of the light emitted by the at least one laser diode.

19. The robot cleaner according to claim 18, wherein the band pass filter transmits light having an infrared wavelength, and wherein the camera receives infrared light.

20. The robot cleaner according to claim 12, wherein the main controller includes a structure light distance measurement device that analyzes a reflection pattern of light reflected by the obstacle from the 3D image received into the camera.
